(19) United States
(12) Patent Application Publication
(10) Pub. No.: US 2025/0173673 A1
(43) Pub. Date: May 29, 2025

(54) SUPPLY AND INVENTORY PREDICTIONS IN SUPPLY CHAIN NETWORKS

(71) Applicant: Noodle Analytics, Inc., San Francisco, CA (US)

(72) Inventors: Hyungil Ahn, San Jose, CA (US); Santiago Olivar Aicinena, Oakland, CA (US); Hershel Amal Mehta, San Francisco, CA (US); Young Chol Song, Menlo Park, CA (US); Naveen Tewari, Unchapul (IN)

(21) Appl. No.: 18/606,972

(22) Filed: Mar. 15, 2024

Related U.S. Application Data
(60) Provisional application No. 63/604,096, filed on Nov. 29, 2023.

(51) Int. Cl. G06Q 10/087; G06N 3/08; G06Q 30/0202

(52) U.S. Cl. CPC G06Q 10/087; G06N 3/08; G06Q 30/0202

(57) ABSTRACT

Successful supply chain optimization must mitigate imbalances between supply and demand over time. To successfully perform supply planning for optimal and viable execution, the predictability for both demand and supply is essential. However, in complex supply chain networks with numerous nodes and edges, accurate supply predictions are challenging due to dynamic node interactions, cascading supply delays, resource availability, production, and logistic capabilities. Consequently, supply executions often deviate from their initial plans. A Graph-based Supply Prediction (GSP) probabilistic model is presented. The attention-based graph neural network (GNN) model predicts supplies, inventory, and imbalances using graph-structured historical data, demand forecasting, and original supply plan inputs. The experiments, conducted using historical data from a global consumer goods company's large-scale supply chain, demonstrate that GSP significantly improves supply and inventory prediction accuracy, potentially offering supply plan corrections to optimize executions.

### CROSS-REFERENCE TO RELATED APPLICATIONS

This application claims the benefit of U.S. Provisional Patent No. 63/604,096, filed Nov. 29, 2023, and entitled “Supply and Inventory Predictions in Supply Chain Networks.” This provisional application is herein incorporated by reference.

### TECHNICAL FIELD

The subject matter disclosed herein generally relates to methods, systems, and machine-readable storage media for predicting the flow of goods in a supply chain network.

### BACKGROUND

Making better supply and inventory predictions is imperative to create an attainable supply plan that effectively matches demand without overstocking or understocking inventory. While considerable efforts have been directed toward improving demand prediction in isolation, comparatively less attention has been given to predicting supply events, lead times, and inventory levels as an integrated whole, accounting for all variabilities in demand and supply.

However, making accurate supply and inventory predictions in complex, large-scale supply chain networks poses significant challenges. This difficulty arises from the need to account for dynamic interactions among interconnected nodes in the network, the ripple effects of supply delays through multi-hop nodes, resource availability, production capacity, and logistics capabilities.

Typically, planned shipments from the Sales and Operations Planning (S&OP) process, which consider limited sets of states, conditions, and constraints, tend to be notably inaccurate and unsuitable for direct execution. Consequently, organizations need to bridge the gap between S&OP shipment plans and day-to-day operational shipment activities, aligning them with financial objectives and tackling supply and demand challenges. Therefore, supply chain operators frequently encounter situations where they cannot act on the planned shipments due to stock shortages and delayed upstream supplies.

### BRIEF DESCRIPTION OF THE DRAWINGS

Various appended drawings illustrate examples of the present disclosure and cannot be considered limiting its scope.

FIG. 1 is an example of a supply chain network.

FIG. 2 illustrates graph node embedding according to some examples.

FIG. 3 is a table illustrating the different approaches to modeling a supply chain network, according to some examples.

FIG. 4 illustrates the calculation of the cumulative supply prediction error, according to some examples.

FIG. 5 illustrates the node-level relationships according to some examples.

FIG. 6 illustrates an example of edge-level shipments.

FIG. 7 illustrates the calculations for predicted, planned, and actual shipments, according to some examples.

FIG. 8 illustrates the predictions of timing and quantity for one event, according to some examples.

FIG. 9 illustrates a complex scenario with three shipment events for a 14-day planning window, according to some examples.

FIG. 10 is a flowchart of a method for model training, according to some examples.

FIG. 11 is a flowchart of a method for model inferencing, according to some examples.

FIG. 12 is a flowchart of a method for processing each event, according to some examples.

FIG. 13 is a flowchart of a method for estimating supply and inventory in a supply chain network, according to some examples.

FIG. 14 is a block diagram illustrating an example of a machine upon or by which one or more example process embodiments described herein may be implemented or controlled.

### DETAILED DESCRIPTION

Example methods, systems, and computer programs are directed to estimating supply and inventory in a supply chain network. Examples merely typify possible variations. Unless explicitly stated otherwise, components and functions are optional and may be combined or subdivided, and operations may vary in sequence or be combined or subdivided. In the following description, numerous specific details are set forth to provide a thorough understanding of examples. However, it will be evident to one skilled in the art that the present subject matter may be practiced without these specific details.

Successful supply chain optimization must mitigate imbalances between supply and demand over time. While accurate demand prediction is essential for supply planning, it alone does not suffice. The key to successful supply planning for optimal and viable execution lies in maximizing predictability for both demand and supply throughout an execution horizon. Therefore, enhancing the accuracy of supply predictions is imperative to create an attainable supply plan that matches demand without overstocking or understocking.

However, in complex supply chain networks with numerous nodes and edges, accurate supply predictions are challenging due to dynamic node interactions, cascading supply delays, resource availability, production, and logistic capabilities. Consequently, supply executions often deviate from their initial plans. To address this, the Graph-based Supply Prediction (GSP) probabilistic model is presented. The attention-based graph neural network (GNN) model predicts supplies, inventory, and imbalances using graph-structured historical data, demand forecasting, and original supply plan inputs. The experiments, conducted using historical data from a global consumer goods company's large-scale supply chain, demonstrate that GSP significantly improves supply and inventory prediction accuracy, potentially offering supply plan corrections to optimize executions.

In one aspect, a novel GNN-based generalized method is presented for predicting event quantity and timing in graph-structured problem contexts where there are planned events without a one-to-one mapping to actual events. This implies that there is no ground truth as labeled data for quantity and timing variables for model learning. The presented approach relies on labeled data in the form of edge-level and node-level aggregated quantities at specific temporal granularities, such as daily or weekly periods.

Further, a prediction error metric called sMACE (scaled Mean Absolute Cumulative Error) is presented to assess the inaccuracies in predictions caused by unpredictable variability in both quantity and timing of events. For example, sMACE may be used to assess the inaccuracies in predictions for supply events and demand events, but it may also be used for other types of prediction problems subject to inadequate predictions. Further, the concept of sMACE is used in the loss function for training GNN-based event delta prediction models.

In the context of supply chain networks, GSP models using the GNN-based generalized method, specifically developed for supply chain network scenarios aiming to predict outgoing shipment events (quantity and timing), are presented.

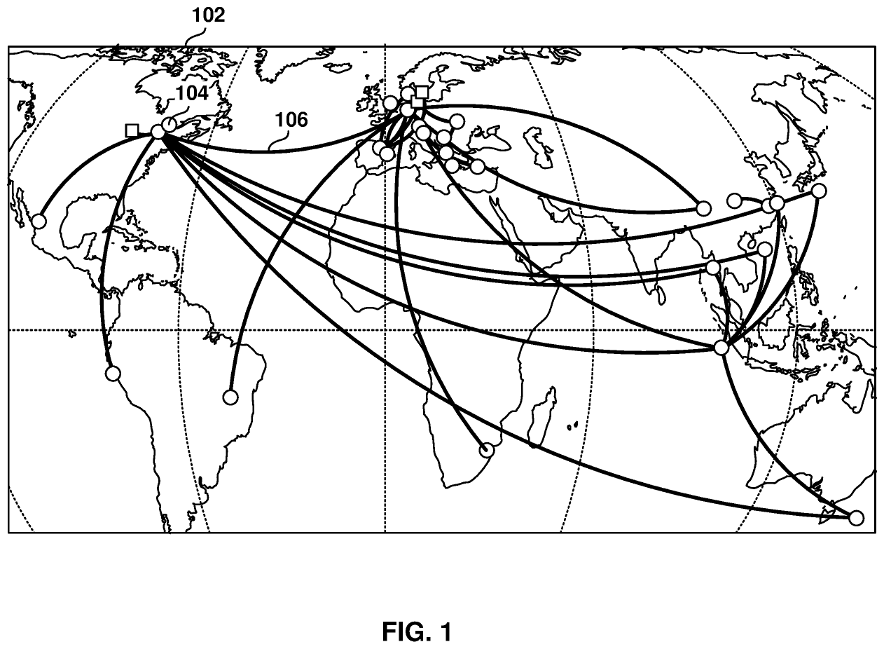

FIG. 1 is an example of a supply chain network 102. The supply chain network 102 is a complex system that involves a multitude of nodes 104 and edges 106. Each node 104 represents a point of activity in the supply chain network 102, such as a plant, distribution centers, and retailers. These nodes are interconnected by edges, which represent the flow of goods and information between the different nodes.

The structure of the supply chain network 102 can vary depending on the industry and the specific products being produced and distributed. Some supply chains may have only a few nodes, while others can involve hundreds or even thousands of different nodes.

Managing a large supply chain network 102 can be challenging due to the large number of nodes 104 and edges 106 involved. Companies have to ensure that each node is operating efficiently and effectively and that the flow of goods between the nodes 104 is optimized. This requires careful planning, coordination, and communication between all parties involved in the supply chain network. The illustrated example is for a supply chain network 102 that encompasses most of the world, so nodes operate in different time zones, and the shipments may take days or weeks to reach their destination.

Performing predictions for the actual inventory in each node at a particular time is a challenging problem because some nodes rely on shipments from other nodes, which may also rely on shipments from other nodes, etc., so estimating inventory for a node requires analyzing the performance of the whole supply chain network, and not just the events on the one node.

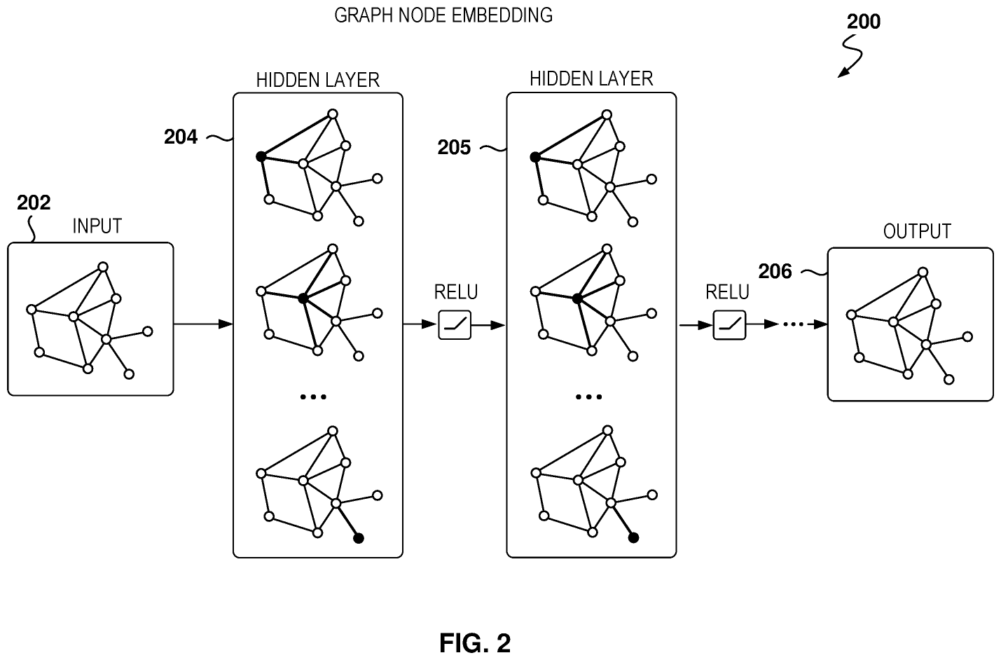

FIG. 2 illustrates a graph node embedding a Graph Neural Network (GNN), according to some examples. In computer science, a graph is a data structure consisting of vertices and edges, and the graph can be described by the set of vertices and edges it contains. The edges can be either directed or undirected, depending on whether there exist directional dependencies between vertices. The vertices are often called nodes.

A GNN 200 is a type of neural network which directly operates on the graph structure. A typical application of GNNs is node classification. A neural network is a computing system based on the consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images. A neural network is based on a collection of connected units called neurons, where each connection, called a synapse, between neurons, can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network that is composed of multiple layers. The layers are composed of nodes, which are locations where computation occurs, loosely patterned on a neuron in the human brain, which fires when it encounters sufficient stimuli. A node combines input from the data with a set of coefficients or weights that either amplify or dampen that input, which assigns significance to inputs for the task the algorithm is trying to learn. These input-weight products are summed, and the sum is passed through what is called a node's activation function to determine whether and to what extent that signal progresses further through the network to affect the outcome.

The GNN 200 uses a cascade of many layers (e.g., input layer 202, layer 204, layer 205, and output layer 206) of non-linear processing units for feature extraction and transformation. Each successive layer uses the output from the previous layer as input. Higher-level features are derived from lower-level features to form a hierarchical representation. The layers following the input layer 202 may be convolution layers that produce feature maps that filter the results of the inputs and are used by the next convolution layer.

In the training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a predetermined range, based on the known training images, backpropagation is used, where backpropagation is a common method of training artificial neural networks that are used with an optimization method such as stochastic gradient descent (SGD) method.

Since the GNN is a neural network, the GNN includes the input layer 202, one or more hidden layers 204-205, and the output layer 206. The nodes in the neural network are graphs.

Graph Neural Networks have benefits that make them suitable for supply-network planning. First, the GNNs exhibit locality properties where the GNN operations propagate information through adjacent nodes. Second, the GNNs exhibit equivariance to permutations, which means that processing the signal with GNN is independent of the node label or the ordering of the nodes. As a result, models learned on one set of graphs can be applied to other graphs with nodes permuted differently or perturbed. GNNs also further allow training on different-sized road network graphs since the GNN weights are independent of the graph size.

GNNs are utilized in the context of supply chain networks due to their effectiveness in representing the graph structure of such networks. The graph structure of a supply chain network consists of nodes and edges, where each node represents a specific entity within the supply chain, and each edge corresponds to a lane or shipment. By using GNNs, it is possible to represent the entire supply chain as a single sample in the algorithms rather than representing each node independently. This allows for the inclusion of node-level features, such as demands and planned shipment information, as well as edge-level features corresponding to shipments. The use of GNNs facilitates the prediction of supply chains and aids in optimizing supply distribution plans.

GNNs are highly effective in representing graph-structured data by generating graph node embeddings. These embeddings are created through graph convolutions that consider both node-level and edge-level features, making them particularly well-suited for capturing the complex dynamics of demand and supply interactions among interconnected nodes via edges.

In some examples, Graph Attention Networks (GAT) are used for making predictions. GATs are a specific type of GNN equipped with dynamic attention mechanisms that empower the model with the capability to dynamically allocate different weights to diverse connections, drawing on information from the present states of both nodes and edges.

It is noted that although the examples are described with reference to GATs, the same principles may be utilized with other neural networks, such as transformers. The examples illustrated should therefore not be interpreted to be exclusive or limiting, but rather illustrative.

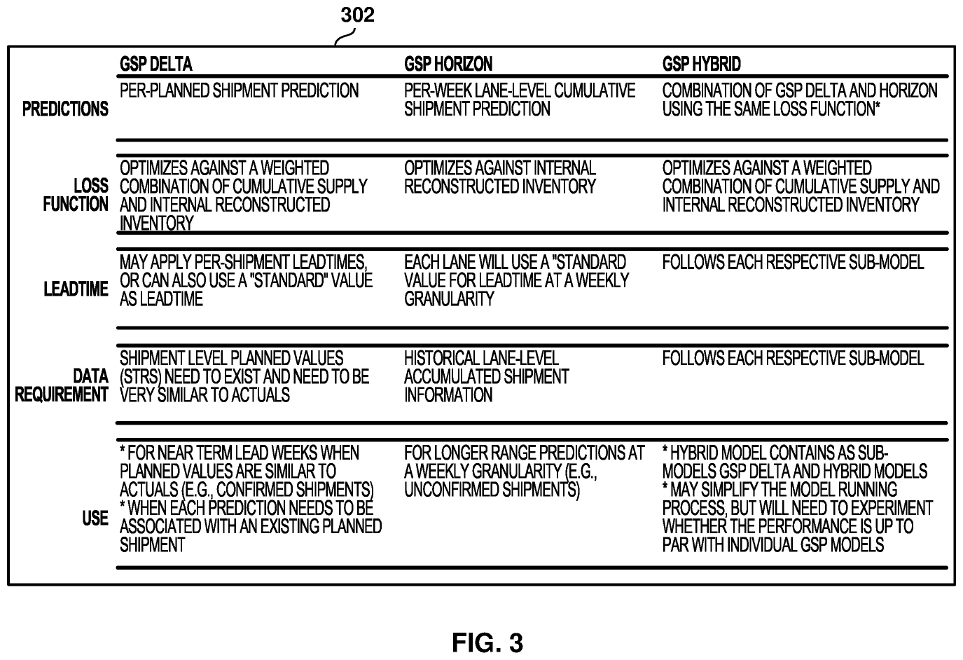

FIG. 3 is a table 302 illustrating the different approaches to modeling a supply chain network, according to some examples. To address the supply and inventory prediction problems, a Graph-based Supply Prediction (GSP) probabilistic model is presented. GSP is tailored for situations where planned shipments and forecasted demand inputs are available over a specified time horizon.

In some examples, an attention-based GNN is used to make network-wide consistent and simultaneous predictions for incoming and outgoing supplies and inventory, relying on sequential graph-structured snapshots of historical supply chain data, demand forecasting, and shipment plan inputs. The objective is to efficiently distribute products from the upper nodes to the downstream nodes, aligning with the demand at each node.

It is noted that the distribution in this context encompasses not only the end product but also all the components and materials involved in the manufacturing process. The focus is on the distribution of goods throughout the supply chain network rather than internal scheduling within a single plant.

The methodology proposed in this disclosure builds upon an existing shipment plan to calculate an estimate of the actual deviation from the existing shipment plan. This is referred to as the GSP delta model or simply as the delta model. The existing plans are subject to changes, and the delta model aims to predict these changes in terms of timing and quantity. This prediction of shipment changes, or deltas, is crucial for effective supply-side predictions. Additionally, the methodology includes lead time predictions, providing insights into the expected duration for shipments to reach their destination.

The delta model assumes that the existing plan is somewhat accurate and aims to make incremental modifications to it. Thus, the delta model is given the existing shipment plan as an input.

Another model is presented for predicting shipment plans without considering the existing plan, that is, predicting shipments from scratch. This model is referred to as the GSP horizon model or simply as the horizon model. The horizon model is used when the existing plans are not considered reliable or do not exist.

A third model is called the GSP hybrid model or simply as hybrid model, and it combines the delta model and the horizon model. For example, the delta predictions are utilized for the initial weeks (e.g., one week, two weeks), while the horizon predictions (e.g., after the first week, after the second week) are employed for the later weeks. This is useful because existing plans tend to be more accurate for the predictions in the short term, but the accuracy tends to decrease as the prediction horizon is expanded. This temporal combination of predictions enhances the overall accuracy of the hybrid model.

Table 302 provides a comparison of the three models and some features of their implementations, which are discussed in more detail below.

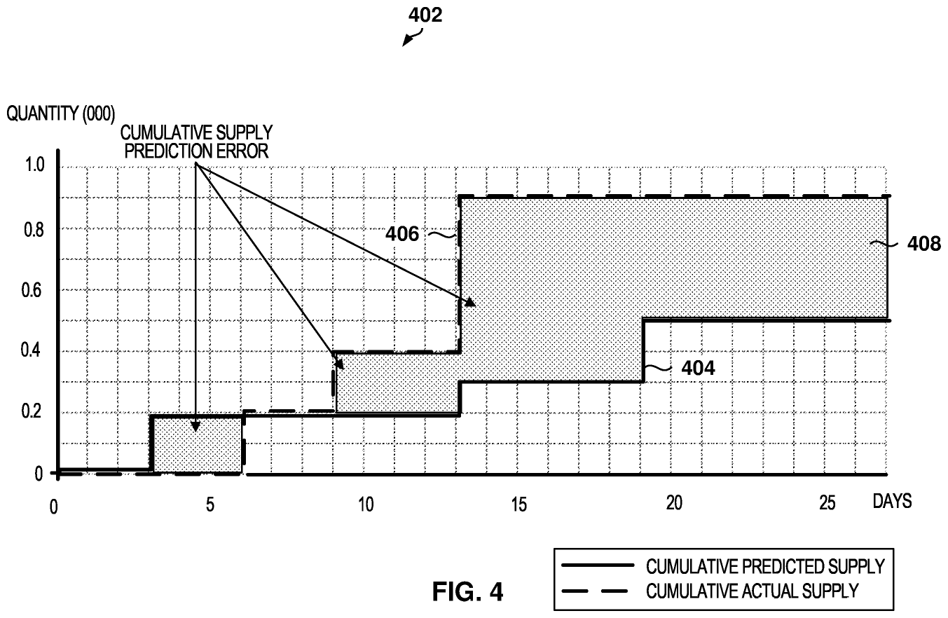

FIG. 4 illustrates the calculation of the cumulative supply prediction error, according to some examples. In some examples, a model-training loss function combines cumulative supply prediction errors with inventory prediction errors, as discussed in more detail below.

Chart 402 shows the cumulative actual supply 406 and the cumulative predicted supply 404, where the horizontal axis is a timescale in days, and the vertical axis is the quantity in thousands. Thus, the cumulative predicted supply 404 includes a shipment of 200 units on day three, a shipment of 100 units on day 13, etc. The cumulative actual supply 406 includes a shipment of 200 units on day six, a shipment of 200 units on day nine, and a shipment of 500 units on day 13.

The difference between the cumulative predicted supply 404 and the cumulative actual supply 406 is the cumulative supply prediction error 408, which is shown in the shaded area. The cumulative supply prediction error 408 is calculated by adding the absolute value of the difference between the cumulative predicted supply 404 and the cumulative actual supply 406 for all the days in the planning horizon. Capturing errors in terms of cumulative predictions and actual risk enables the methodology to capture the errors in both timing and quantity.

This example illustrates the prediction inaccuracies attributed to the unpredictable supply variability in both the quantity and the timing of shipment events throughout the time horizon. It is noted that in an edge with a consistent lead time, the cumulative outgoing supply quantity from the source node over the time horizon has a proportional impact on the inventory level at the destination node.

Moreover, it is noted that frequently, the objective extends beyond merely predicting the supply itself; instead, sometimes, analysts focus on forecasting key performance metrics such as service level, fill rate, and the total economic cost associated with imbalanced risks (e.g., lost sales and excess inventory). In this context, it is useful to train the model to predict both inventory levels and supply coherently, taking into account the provided demand prediction inputs.

The inclusion of inventory prediction errors in the loss function accounts for the comprehensive impact of demand and supply variabilities on the accuracy of inventory predictions since the inventory of each node is a result of the cumulative sums of incoming supply, outgoing supply, and demand.

Some experiments conducted using historical data from a complex supply chain network of a global consumer goods company demonstrated that GSP achieves substantial enhancements in both supply and inventory prediction accuracy. These improvements have the potential to drive corrective adjustments in supply plans, ultimately leading to more optimal executions.

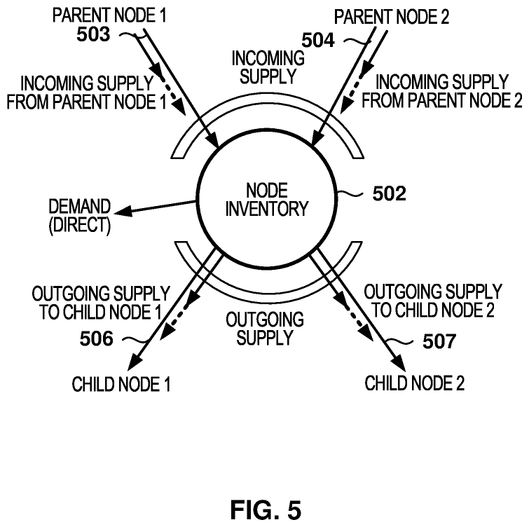

FIG. 5 illustrates the node-level relationships according to some examples. A node 502 has a certain inventory. Incoming supplies are coming from other nodes (e.g., incoming supply 503 from parent node 1 and incoming supply 504 from parent node 2), and outgoing shipments are going to other nodes (e.g., outgoing and supply 506 to child node 1, and ongoing supply 507 to child note 2). Based on these shipments, the current level of inventory may be calculated.

Once the incoming shipments are estimated, the outgoing shipments may also be calculated based on the demands from those nodes and the level of inventory at the time, as discussed above.

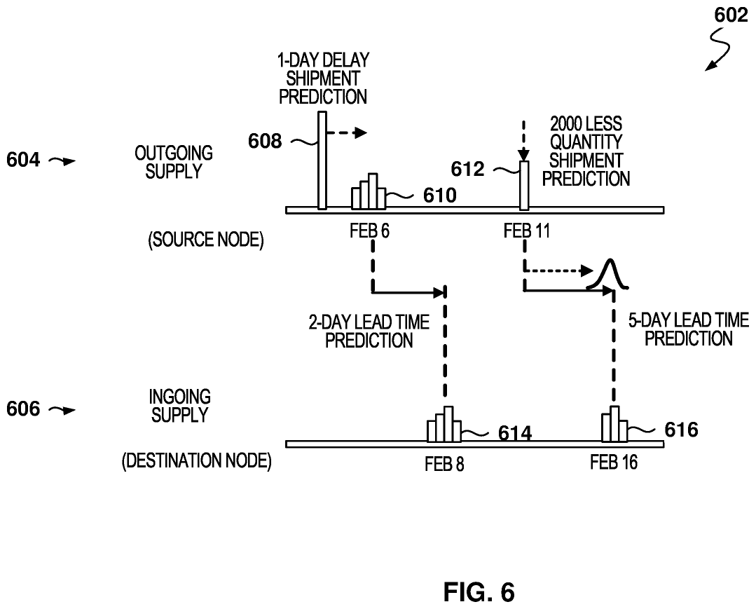

FIG. 6 illustrates an example of edge-level shipments. The chart 602 includes the outgoing supply 604 (from a source node) and the incoming supply 606 over time (for a destination node). The outgoing supply 604 shows that there is a one-day delay 610 on a shipment versus the predicted shipment 608, which means that the shipment was shipped on February 6 instead of February 5. As seen in the outgoing supply 604, the shipment may even be predicted over a probability curve, showing that there may be multiple shipments on multiple days instead of just one predicted shipment.

Further, for February 11, the outgoing supply 604 shows that there was a shipment 612 but with a shortage of 2000 units. On the destination node, the one-day delay 610 shows two days later for lead time as incoming shipment 614, and the shipment 612 shows as shipment 616 five days after the shipment leaves the source node.

In the supply chain network, each Stock Keeping Unit (SKU) (unique identifier for each item being shipped) is associated with its own distinct topological graph. Further, [symbol] =(V, E) denotes a directional graph for the SKU-specific supply chain network, containing a collection of nodes V={1, . . . , n} with diverse node types (e.g., plants, distribution centers, retailers) and edges ε ∈ {V×V} where (v, w) ∈ ε denotes an edge from a source node v to a destination node w. For ease of notation and without loss of generality, the SKU-specific subscript is dropped from most notations unless otherwise indicated.

The nodes and edges in [symbol] at time t are associated with a set of node feature vectors x^{t}={xᵥ^{t} ∈ [symbol] ^{d}^{₁}:v ∈ [symbol] ^{|V|×d}^{₁}} and a set of edge feature vectors a^{t}={a_{vw}^{t} ∈ [symbol] ^{d}^{₂}:(v, w) ∈ ε} ∈ [symbol] ^{|ε|×d}^{₂}, where d₁ is the number of node features and d₂ is the number of edge features. In addition, let [symbol] ^{R}=(V, ε^{R}) denote the reverse graph of [symbol] with the same nodes and features but with the directions of all edges reversed, that is, ε^{R}={(w, v)|(v, w) ∈ ε}.

The presented models make supply and inventory predictions in supply chain networks where the input data includes planned shipment events and weekly demand forecasting over the specified time horizon. In general, the planned shipment event information is acquired from the enterprise's planning system's original supply plan, which frequently falls short of being feasible for execution as originally devised.

In some examples, the objective is to minimize the average absolute errors of edge-level daily outgoing supply cumulative predictions and the average absolute errors of node-level weekly inventory predictions. The evaluation metrics are defined in a normalized manner. The first metric is the daily outgoing supply prediction, referred to herein as sMACE, which is defined as follows:

$$sMACE = \frac{{\sum }_{h ∈ H} \vert {\hat{Q}}_{v w}^{day , t} ( h ) - {Q}_{v w}^{day , t} \vert}{{\sum }_{h ∈ H} {q}_{v w}^{day , t} ( h )} \times 100 \% \qquad ( 1 )$$

Thus, sMACE calculates the normalized cumulative error over the planning horizon, and the denominator in (1) is a normalizing scaler. In equation (1), the predicted cumulative daily quantity vector \hat{Q}_{vw}^{day,t} (e.g., the supply), and the actual cumulative daily quantity vector Q_{vw}^{day,t} of outgoing supply are defined as:

$$\begin{matrix}{\hat{Q}}_{v w}^{day , t} = \{ {\hat{Q}}_{v w}^{day , t} ( h ) {\sum }_{d = 0}^{h} {\hat{q}}_{v w}^{day , t} ( d ) \vert h ∈ H \} , \\ {Q}_{v w}^{day , t} = \{ {Q}_{v w}^{day , t} ( h ) {\sum }_{d = 0}^{h} {q}_{v w}^{day , t} ( d ) \vert h ∈ H \}\end{matrix} \qquad ( 2 )$$

The inventory prediction is made at the node level. In equation (2), \hat{q}_{vw}^{day,t}(d) is the predicted daily quantity of outgoing supply for day d in a time horizon H in days (i.e., H={0, 1, 2, . . . , |H|−1}) from source node v to destination node w at the prediction time t. Further, q_{vw}^{day,t}(d) is the actual daily quantity (as ground truth) of outgoing supply for day t+d on the edge from v to w. That is, t is the time when the prediction is made, and t+d is the target time to be predicted (within the H window). Thus, [symbol] is the cumulative error for all the daily errors represented by q; the daily errors are calculated, and then the cumulative value of the error is calculated.

Further, the weekly inventory prediction, referred to as wMAPE, is defined as follows:

$$wMAPE = \frac{{\sum }_{w ∈ W} \vert {\hat{I}}_{v}^{week , t} ( w ) - {I}_{v}^{w eek , t} ( w ) \vert}{{\sum }_{w ∈ W} {I}_{v}^{week , t} ( w )} \times 100 \% \qquad ( 3 )$$

In equation (3), Îᵥ^{week,t}(w) is the weekly predicted inventory for node v (e.g., the node-level truth value) over the weekly time horizon W={0, 1, 2, . . . , |W|−1} at week t, and Iᵥ^{week,t}(w) is the weekly actual inventory for node v over the weekly time horizon W. In this example, |W|=|H|/7, but other examples may utilize different time horizon periods. In this way, the edge-level prediction error is calculated and combined with the node-level prediction errors to make a good prediction in the shipment timing and amount deltas.

In some examples, the planning horizon may be four weeks or 12 weeks, but other volumes are also possible. Although the example is illustrated with reference to weekly predictions, other examples may utilize other scales, such as daily or monthly predictions.

Before introducing GSP models for shipment event predictions in supply chain networks, a generalized method is described for GNN-based event quantity/timing delta predictions in graph-structured problem contexts where there is information about planned events, but there is no one-to-one mapping with actual events for these planned events. Therefore, in this problem setting, there is no ground truth available as labeled data for quantity/timing variables in model learning. However, an assumption is made that labeled data (the ground truth) is obtainable in the form of edge-level and node-level aggregated quantities at specific temporal granularities, such as in daily or weekly periods.

The node vectors are calculated for each node, and these node vectors are also referred to as embedding vectors that represent the features of a node. The node is not considered in isolation based on the node features alone. Still, the model also takes into account the features of nearby nodes, as well as the edge features of nearby nodes, to calculate the embedding vector for one node.

The calculation of the node vectors is performed for all the nodes in a process that is called convolution, and the convolutions may be repeated to add more levels, and as more convolutions are performed, the node vectors will end up representing the interactions of the node with the rest of the network.

In some examples, GATs are used for modeling the supply chain network. With GATs, dynamic attention enables a node to selectively attend to its neighboring nodes that are highly relevant in its supply predictions. Provided node features h⁽⁰⁾ (the original node features) and edge features e for [symbol] =(V,ε), GAT_{XA} (Appendix A) denotes the L-layered graph convolution network that makes iterative updates l=1, 2, . . . ,L and calculates h^{(L)} as follows:

$${h}^{( L )} = G A {T}_{X A} ( {h}^{( 0 )} , e , 𝒢 ; {ϕ}_{X A} ) = \{ {h}_{v}^{( L )} ∈ {ℝ}^{B} : v ∈ V \} ∈ {ℝ}^{B \times \vert V \vert} \qquad ( 4 )$$

In equation (4), ϕ_{XA} is the set of all learned parameters of GAT_{XA} and B is the embedding dimension. It is noted that the node features h⁽⁰⁾ are the same as x, and the edge features e are the same as a used in the equations above.

The graph node embedding u for a given pair of node features x and edge features a is defined as follows:

$$u {=}^{def} {emb}_{XA} ( x , a ; {ϕ}_{X {A}_{f}} , {ϕ}_{X {A}_{b}} ) = [ {u}_{f} ‖ {u}_{b} ] ∈ {ℝ}^{2 B \times \vert V \vert} \qquad ( 5 )$$

In equation (5), u_{f}=GAT_{XA}(x, a, [symbol] ; ϕ_{XA}_{_{f}}) and u_{b}=GAT_{XA}(x, a, [symbol] ^{R}; ϕ_{XA}_{_{b}}). It is noted that u_{f} and u_{b} each are calculated using the forward-directional (original) graph and the backward-directional (reverse) graph, respectively. The u_{f} embedding vectors from graph [symbol] incorporate the competing and collaborative dynamics of multiple source nodes to a destination node into their own attention, whereas the us embedding vectors from reversed graph [symbol] ^{R} encompass the interactions of multiple destination nodes to a source node into their respective attentions.

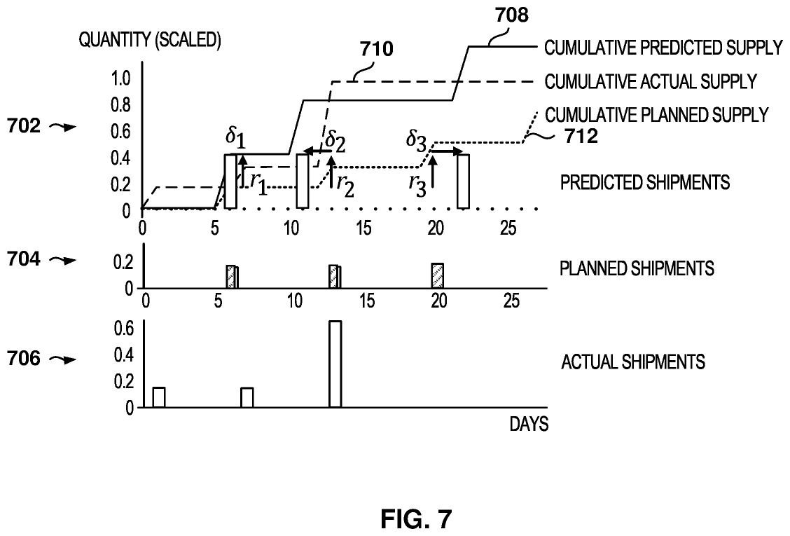

FIG. 7 illustrates the calculations for predicted, planned, and actual shipments, according to some examples. The chart 702 shows the predicted segments, the chart 704 shows the planned shipments, and the chart 706 shows the actual shipments.

Based on these values, it is possible to estimate the cumulative predicted supply 708 based on predicted shipments, the cumulative actual supply 710 based on the actual shipments, and the cumulative planned supply 712 based on the planned shipments.

One goal for the model is to estimate the cumulative predicted supply 708 and make it as close as possible to the cumulative actual supply 710 to minimize the cumulative errors. If the cumulative supply prediction error 408 is equal to the cumulative actual supply 710, then this means that the actual shipments are correctly predicted. It is noted that, in some examples, the cumulative shipments are compared instead of focusing on each individual shipment. The cumulative predictions are important to show how the cumulative supply predictions are close to the actual cumulative supply because both the timing errors and the quantity errors are important in the final metrics.

The probabilistic event prediction model is described next. The probabilistic event prediction model leverages GAT graph embedding to predict the timings and quantities of events at every edge, provided the information on the timings and quantities of originally planned events. Specifically, τ_{vw}^{i|t} ∈ H={0, 1, 2, . . . , |H|−1} is the originally planned time of event i elapsed from the current time t. That is, the event i on the edge from v to w is planned to occur at time t+τ_{vw}^{i|t}. Further, the planned outgoing shipment quantity of event i is denoted as a_{vw}^{i|t} ∈ [symbol] .

Given τ_{vw}^{i|t} and a_{vw}^{i|t} of the i-th planned event (i ∈ {1, 2, . . . , |H|}) on the edge from v to w at the prediction time t, we predict P_{vw}^{i|t}(δ) and â_{vw}^{i|t}. P_{vw}^{i/51 t}(δ) is the predicted discrete probability distribution of the time difference variable δ (in days) between the actual event time and the originally planned event time where δ ∈ Δ={−7,−6, . . . , −1,0,1, . . . , 6,7}, and P_{vw}^{i|t}(δ) is the probability of predicted time difference δ−δ. The predictions of |H| events cover the maximum possible count of daily events over the |H| days.

Further, the predicted shipment quantity â_{vw}^{i|t}=r_{vw}^{i|t}a_{vw}^{i|t} ∈ [symbol] is calculated using r_{vw}^{i|t} ∈ (0,2] as a predicted multiplier. Alternatively, the predicted shipment quantity may be modeled to depend δ: a_{vw}^{i|t}(δ)=min{0,(r_{vw}^{i|t}+δ s_{vw}^{i|t})} a_{vw}^{i|t} ∈ [symbol] where r_{vw}^{i|t} ∈ (0,2] and s_{vw}^{i|t} ∈ [−1,1] are predicted multipliers. Note that s_{vw}^{i|t} may capture a potential correlation between the time difference (earlier or later than the planned shipment time) and the shipment quantity (larger or smaller than the quantity on time). Furthermore, P(â_{vw}^{i|t}, δ _{vw}^{i|t})=P(â_{vw}^{i|t}|δ _{vw}^{i|t})P(δ_{vw}^{i|t}). An extension employing Bayesian regression allows for modeling the quantity prediction as a conditional probability P(â_{vw}^{i|t}|δ _{vw}^{i|t})

This approach is unique because prior approaches utilize the given ground truth label on the quantity and timing variables themselves. However, in the presented approach, the graph is a neural net structure, and graph data is used to predict quantity and timing without any known ground truth at the level of content and timing variables. However, there is a ground truth in the form of the edge-level daily supply and the node-level weekly inventory, which is unique.

The r^{i|t} and the P^{i|t}(δ) are calculated as follows:

$${r}^{i \vert t} = \{ {r}_{v w}^{i \vert t} \vert ( v , w ) ∈ ℰ \} ∈ {ℝ}^{\vert ℰ \vert} ; {P}^{i \vert t} ( δ ) = \{ {P}_{v w}^{i \vert t} ( δ ) \vert ( v , w ) ∈ ℰ \} ∈ {ℝ}^{\vert ℰ \vert \times \vert Δ \vert} \qquad ( 6 )$$

For each i planned event, the GAT-based prediction model M predicts the i^{th} event at time t as follows:

$$( {r}^{i \vert t} , {P}^{i \vert t} ( δ ) ) = M ( {x}^{t} , {a}^{t} ( i ) ) \qquad ( 7 )$$

Equation (7) takes edge-level features a^{t}(i)={a_{vw}^{t}(i)|(v, w) ∈ ε} and node-level features x^{t}={xᵥ^{t}|v ∈ V} as inputs. For simplicity, it is assumed that the node-level features are dependent only on the prediction time t, not the prediction target event i.

For the edge-level features, as the default setting, the following equation is used:

$${a}_{vw}^{t} ( i ) = \{ {τ}_{vw}^{i \vert t} , {a}_{vw}^{i \vert t} \} ⋃ \{ {τ}_{vw , hist}^{- k \vert t} , {a}_{v , w , hist}^{- k \vert t} \vert k = 0 , 1 , 2 , … , K - 1 \} \qquad ( 8 )$$

In equation (8), τ_{vw,hist} ^{-k|t} and a_{v,w,hist} ^{-k|t} represent historical shipment event times and quantities, with k=0 denoting the most recent event before time t.

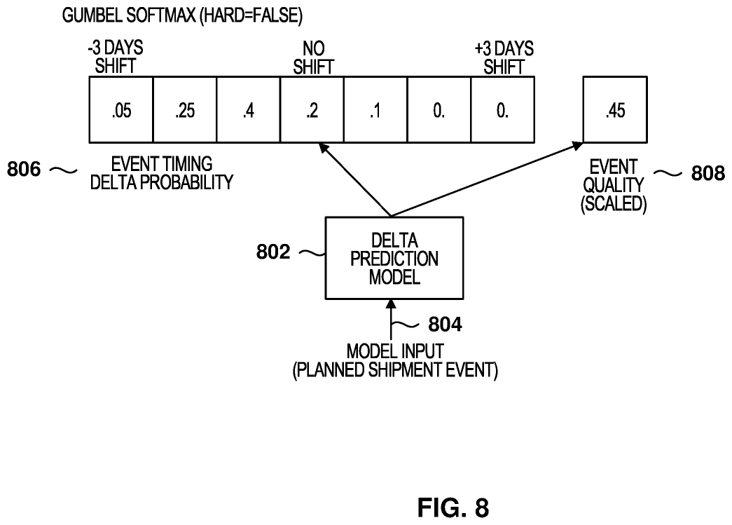

FIG. 8 illustrates the predictions of timing and quantity for one event, according to some examples. FIG. 8 shows the inputs and the outputs of the model M 802. In some examples, the delta prediction model M 802 received as input 804 the planned shipment events, and the model M 802 generates two outputs: the shift in time for shipment events (event timing delta probability 806) and the change in quantity for the shipment events (event quantity 808).

The event quantity 808 is expressed as a scaling factor to be applied to the actual predicted shipment. For example, if a shipment is for 300 units and the event quantity 808 is 0.45, the actual shipment would be 300×0.45, which is equal to 135.

In the illustrated example, probabilities for the time delays of a shipment are provided. The probability of no shift in time, that is, the shipment going out as scheduled, is 0.2. Further, the probability that the shipment ships three days earlier is 0.05, the probability that the shipment ships one day late is 0.1, etc.

To predict r^{i|t} and P^{i|t}(δ), the model M 802 begins by calculating GAT embeddings u_{f} and u_{b}, taking x^{t} and a^{t}(i), as outlined in equation (5). Then, using the graph node embeddings uᵥ=[u_{f,v}∥u_{b,v}]and u_{w}=[u_{f,w}∥u_{b,w}] for nodes v and w, the r_{vw}^{i|t} is calculated as follows:

$${r}_{vw}^{i \vert t} = {mlp}_{r} ( [ {u}_{v} ‖ {u}_{w} ] ) ∈ ( 0 , 2 ] \qquad ( 9 )$$

In equation (9), mlpᵣ is a multilayer feedforward network with an output of sigmoid multiplied by 2.0. Further, ρ_{vw}^{i|t}(δ) is calculated as follows:

$${p}_{vw}^{i \vert t} ( δ ) = GumbelSoftmax [ {mlp}_{p} ( [ {u}_{v} ‖ {u}_{w} ] ) ] ∈ {[ 0 , 1 ]}^{\vert Δ \vert} \qquad ( 10 )$$

Gumbel-Softmax is a technique used in machine learning to approximate samples from a categorical distribution in a way that is differentiable, meaning it can be used with backpropagation for training neural networks. Further, mlpₚ is a multilayer feedforward network, and GumbelSoftmax is used to sample from a categorical distribution in the forward pass and be differentiable in backprop. It is noted that the predicted time of an event τ_{vw}^{i|t}+δ should be zero or a positive integer. Thus, it is only allowed δ≥−τ_{vw}^{i|t}, and update the probability of

$$δ = 0 by {p}_{vw}^{i \vert t} ( 0 ) := {\sum }_{{δ}^{′} < - {τ}_{vw}^{i \vert t}} {p}_{vw}^{i \vert t} ( {δ}^{′} ) .$$

The aggregation of the event predictions into the vector of daily event quantities over a defined time horizon (|H| days, H={0,1,2, . . . , |H|−1}), denoted as \hat{q}_{vw}^{day,t} ∈ [symbol] ^{|H|} on the edge from node v to node w at the prediction time t(=the start of day t) is calculated. However, the methodology can be flexibly applied to time granularities other than the daily level.

For any event time f′ ∈ H elapsed from the current time t,e^{(t′}) ∈ [symbol] ^{|H|}is the standard basis vector [0, . . . , 0, 1, 0, . . . ,0] with a 1 at position t′+1. It is noted that the probability distribution of the planned event time is described as e^{(τ}^{_{vw}}^{^{i|t}} ∈ [symbol] ^{|H|}, which assigns the full probability 1 to the element corresponding to the planned event time τ_{vw}^{i|t}.

Using ρ_{vw}^{i|t} (δ) and τ_{vw}^{i|t}, the probability distribution of the predicted event time \hat{τ}_{vw}^{i|t} is calculated over the time horizon H as follows:

$${π}_{vw}^{i \vert t} = {\sum }_{δ ∈ Δ} {p}_{vw}^{i \vert t} ( δ ) {e}^{( {τ}_{vw}^{i \vert t} + δ )} ∈ {ℝ}^{\vert H \vert} \qquad ( 11 )$$

Then, the predicted quantity distribution vector of event i over the time horizon H is calculated as follows:

$${q}_{vw}^{i \vert t} = {r}_{vw}^{i \vert t} {a}_{vw}^{i \vert t} {π}_{vw}^{i \vert t} = {r}_{vw}^{i \vert t} {a}_{vw}^{i \vert t} {\sum }_{δ ∈ Δ} {p}_{vw}^{i \vert t} ( δ ) {e}^{( {τ}_{vw}^{i \vert t} + δ )} ∈ {ℝ}^{\vert H \vert} . \qquad ( 12 )$$

The predicted daily quantity vector is calculated as follows:

$${\hat{q}}_{vw}^{day , t} = {\sum }_{i ∈ {A}_{vw}^{t}} {\hat{q}}_{vw}^{i \vert t} ∈ {ℝ}^{\vert H \vert} \qquad ( 13 )$$

In equation (13), [symbol] _{vw}^{t}={i ∈ [symbol] |τ_{vw}^{i|t} ∈ H} is the set of all planned events at time t over the time horizon H. Further, the predicted and actual cumulative daily quantity vectors are defined as:

$$\begin{matrix}{\hat{Q}}_{vw}^{day , t} = \{ {Q}_{vw}^{day , t} ( h ) = {\sum }_{d = 0}^{h} {q}_{vw}^{day , t} ( d ) \vert h ∈ H \} , \\ {Q}_{vw}^{day , t} = \{ {Q}_{vw}^{day , t} ( h ) = {\sum }_{d - 0}^{h} {q}_{vw}^{day , t} ( d ) \vert h ∈ H \}\end{matrix} \qquad ( 14 )$$

In equation (14), \hat{q}_{vw}^{day,t}(d) is the predicted daily quantity for day d in H on the edge from v to w at the prediction time t. Also, q_{vw}^{day,t}(d) is the actual daily quantity (as ground truth) for day t+d on the edge from v to w.

Further, the set of parameters θ_{M} of the prediction model includes θ_{M}={ϕ_{XA}_{_{f}}, ϕ_{XA}_{_{b}}, ϕₘₗₚ_{ₚ}, ϕₘₗₚ_{ᵣ}}.

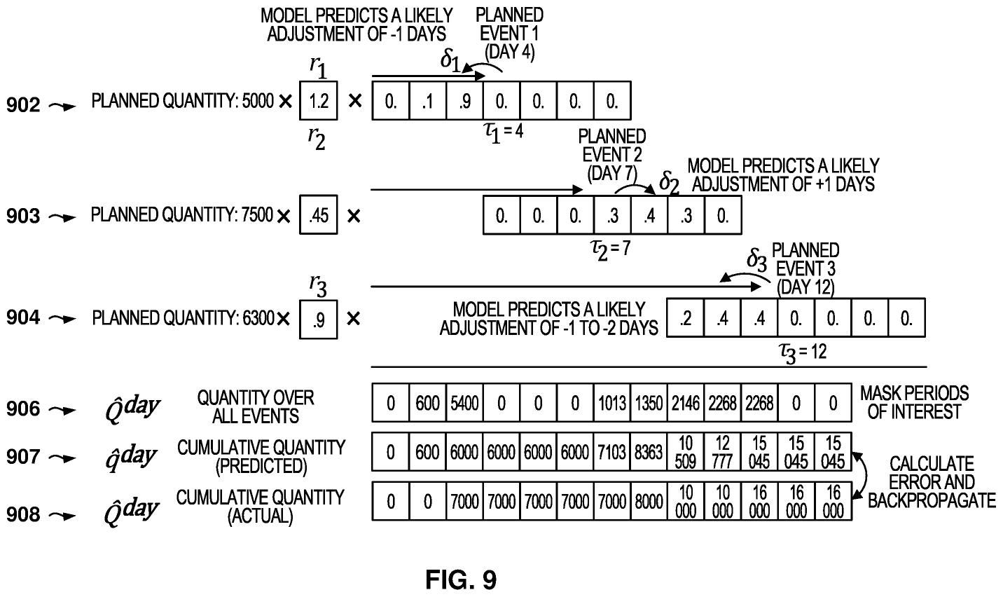

FIG. 9 illustrates a complex scenario with three shipment events for a 14-day planning window, according to some examples. FIG. 9 illustrates the calculation of predicted vectors over H=14 days for given t and (v,w).

In this example, there are three shipments 902-904 with different planned quantities. Shipment 902 is for 5000 units, shipment 903 is for 7500 units, and shipment 904 is for 6300 units. Each shipment has a planned day in the original plan (e.g., base 4, 7, and 12).

As described in FIG. 8, each shipment has a probability distribution for actual shipments being shipped before, on, or after the planned date. Further, there are also respected shipment quantity factors rᵢ for each shipment. In this example, the time horizon H is for 14-day predictions with planned shipments on days 4, 7, and 12.

The quantity over all events 906 is calculated by combining the quantities from the planned events. Further, the predicted cumulative quantity 907 is calculated by adding the predicted shipments for the respective days, and the actual cumulative quantity 908 is also calculated based on the actual shipments. That is, the parameters for the three events are calculated by combining the individual shipments.

The predicted event aggregation into node-level quantities over time is described next. It is supposed that there are node-level labeled quantities (as ground truth) that the process aims to incorporate into the model training for event quantity and timing delta predictions, along with the edge-level labeled quantities. Also, it is assumed that there exists a pre-determined process model Z that takes edge-level predicted quantity vectors {\hat{q}_{vw}^{day,t}|(v, w) ∈ ε} as inputs and predicts node-level aggregated quantity vectors {Î_{vw}^{week,t}|(v, w) ∈ [symbol] } in a different time granularity (a week for an illustration here) as outputs where Îᵥ^{week,t}={Îᵥ^{w|t}|w ∈ W} for the weekly time horizon W={0, 1, 2, . . . , |W|−1} and |W|=|H|/7. That is:

$$\{ {\hat{I}}_{v}^{week , t} \} = Z ( \{ {\hat{q}}_{vw}^{day , t} \} ) \qquad ( 15 )$$

The node-level labeled quantities (as ground truth) are notated as Iᵥ^{week,t}={I_{v,actual}^{t+w}|w ∈ W} where I_{v,actual}^{t+w} is the actual quantity in node v at the start of time t.

To define the loss function, it is defined that θ_{M} is the set of parameters of prediction model M(x,a;θ_{M}). The loss function [symbol] (θ_{M}) combines edge-level cumulative outgoing supply prediction errors with node-level inventory prediction errors. The loss function [symbol] (θ_{M}) is defined as follows:

$$ℒ ( {θ}_{M} ) = ( 1 - α ) [ {‖ {\hat{Q}}_{vw}^{day , t} - {Q}_{vw}^{day , t} ‖}_{2}^{2} ] + [ {‖ {\hat{I}}_{v}^{week , t} - {I}_{v}^{week , t} ‖}_{2}^{2} ] \qquad ( 16 )$$

In equation (16), α ∈ [0,1] is a hyperparameter that controls the balance of the two loss components. When the loss function is set with α=0, it enables model training exclusively with edge-level labeled quantities. Conversely, when α=1, it does model training solely with node-level labeled quantities. Further, θ_{M} by is optimized by minimizing the loss function [symbol] (θ_{M}) over the dataset [symbol] through backprop.

The GSP models are built by applying the generalized method previously described to supply chain network scenarios where the goal is to predict outgoing shipment events (quantity and timing). Due to limitations in the underlying supply chain processes and systems for tracking actual shipments against planned shipments, it is often not possible to establish a direct one-to-one correspondence between actual and planned shipments. Consequently, there may be a lack of precise information regarding the exact discrepancies between actual and planned shipments in terms of both shipment event quantity and timing.

Nevertheless, there are the edge-level daily outgoing supply quantities ({q_{vw}^{day,t}}) and the node-level weekly inventory quantities ({Iᵥ^{week,t}}) available for use as ground-truth labels in model training and evaluation. The prediction model M in equation (7) takes as inputs the edge-level features, configured by default in equation (8), along with the node-level features defined as follows:

$$\begin{matrix}{x}_{v}^{t} = \{ {I}_{v , actual}^{t} \} ⋃ \{ {I}_{v , plan}^{w \vert t} \vert w = 1 , 2 , … , \vert W \vert - 1 \} \\ ⋃ \{ {𝒟}_{v , pred}^{w \vert t} , {S}_{v , plan}^{w \vert t} , {A}_{v , plan}^{w \vert t} \vert w = 0 , 1 , … , \vert W \vert - 1 \}\end{matrix} \qquad ( 17 )$$

I_{v,actual}^{t} is the actual inventory at the start of time t. These are node-level features. Also, I_{v,plan}^{w|t}, [symbol] _{v,pred}^{w|t}, S_{v,plan}^{w|t}, and A_{v,plan}^{w|t} are planned inventory. predicted demand, planned incoming supply, and planned outgoing supply for week was predicted at the start of week t, respectively. It is assumed that these weekly demand forecasting and planning features are obtained from the organization's existing planning system.

The node-level weekly predicted inventory vectors {Îᵥ^{week,t}}=Z({\hat{q}_{vw}^{day,t}}) are computed using the inventory prediction process model Z, described in Appendix D. It is noted that the model Z internally relies on an edge-level model for probabilistic discrete lead time prediction P_{LT,vw}^{t+h}(k) where P_{LT,vw}^{t+h}(k) is the probability of predicted lead time k=k ∈ H for any outgoing supply at day t+h.

In the context of network-wide supply event predictions, it is important to predict the sequence of events propagating through nodes and edges. This requires connected predictions that span across nodes and edges in the network. Appendix F illustrates our approach for iterative and simultaneous predictions that allow for satisfying each node's supply capacity constraint, which is affected by the supply executions of other neighboring nodes in a cascading manner.

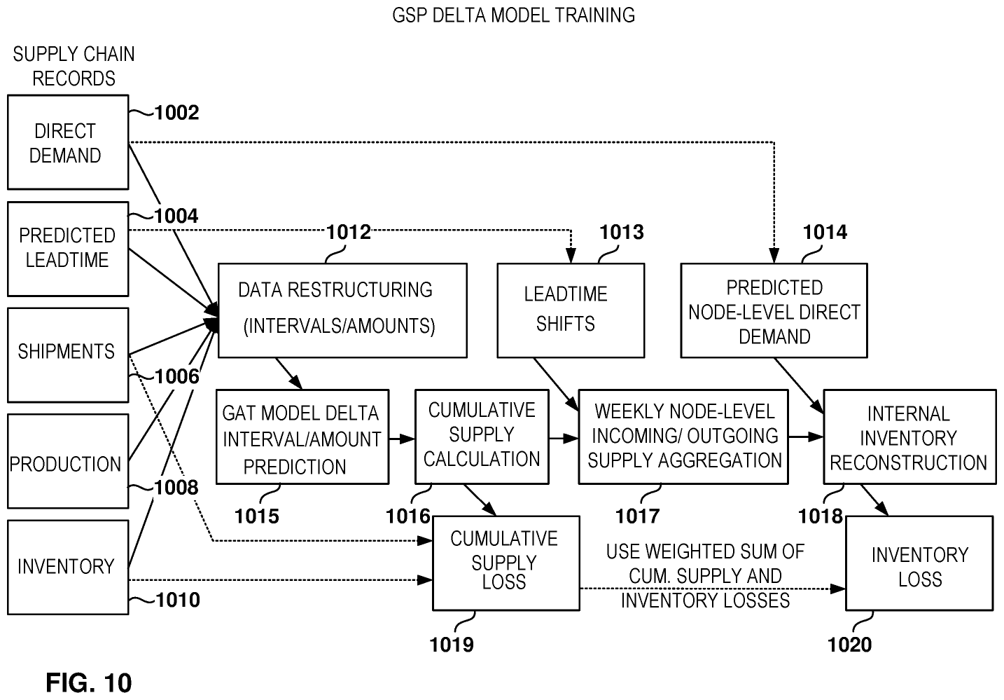

FIG. 10 is a flowchart of a method for model training, according to some examples. In some examples, the direct demand 1002, predicted lead time 1004, shipments 1006, production details 1008, and inventory 1010 are fed as input to the data restructuring 1012 process that calculates the intervals and the amounts.

Further, the lead time 1004 is used to calculate lead time shifts 1013, and the direct demand 1002 is used as input to calculate the predicted node-level direct demand 1014. The data restructuring 1012 is fed as input to the GAT model 1015, which performs the cumulative supply calculation 1016.

Based on the cumulative supply calculation 1016 and the lead time shifts 1013, the weekly node-level incoming/outgoing supply aggregation 1017 is calculated. Further, the predicted node-level direct demand 1014 and the outgoing supply aggregation 1017 are used to perform internal inventory reconstruction 1018.

Further, the shipments 1006 and the inventory 1010 are used to calculate the cumulative supply loss 1019. The cumulative supply loss 1019 and the internal inventory reconstruction 1018 are used to calculate the inventory loss 1020.

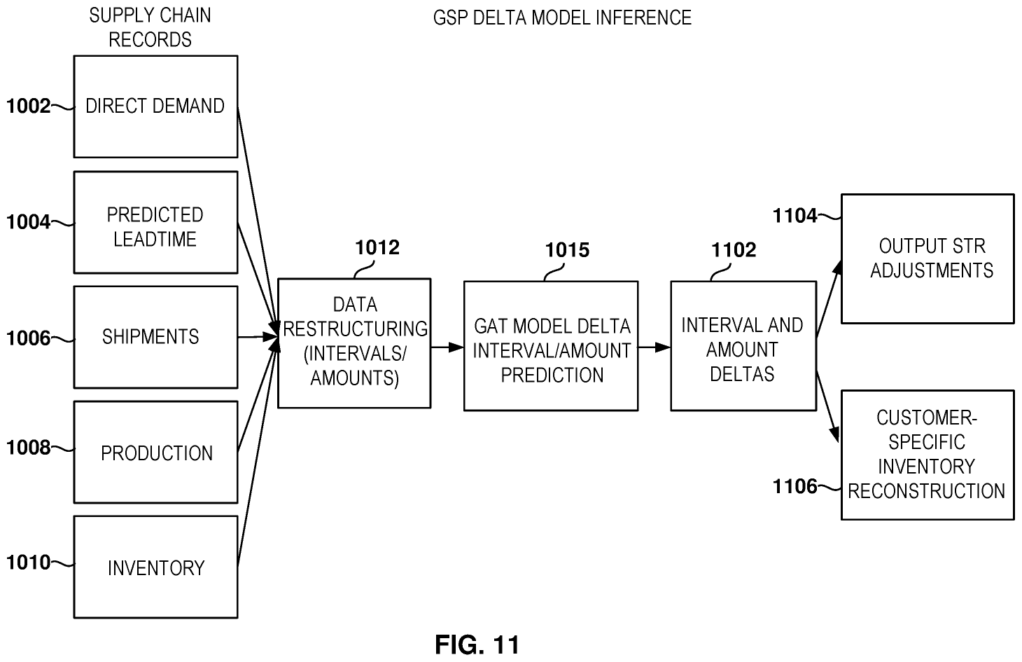

FIG. 11 is a flowchart of a method for model inferencing, according to some examples. During inference, the direct demand 1002, lead time 1004, shipments 1006, production details 1008, and inventory 1010 are used as input for the data restructuring 1012 (for intervals and amounts).

The data restructuring 1012 is used as input for the GAT model 1015, which outputs the interval and amount deltas 1102. The amount deltas 1102 are used for both the output shipment adjustments 1104 and the customer-specific inventory reconstruction 1106.

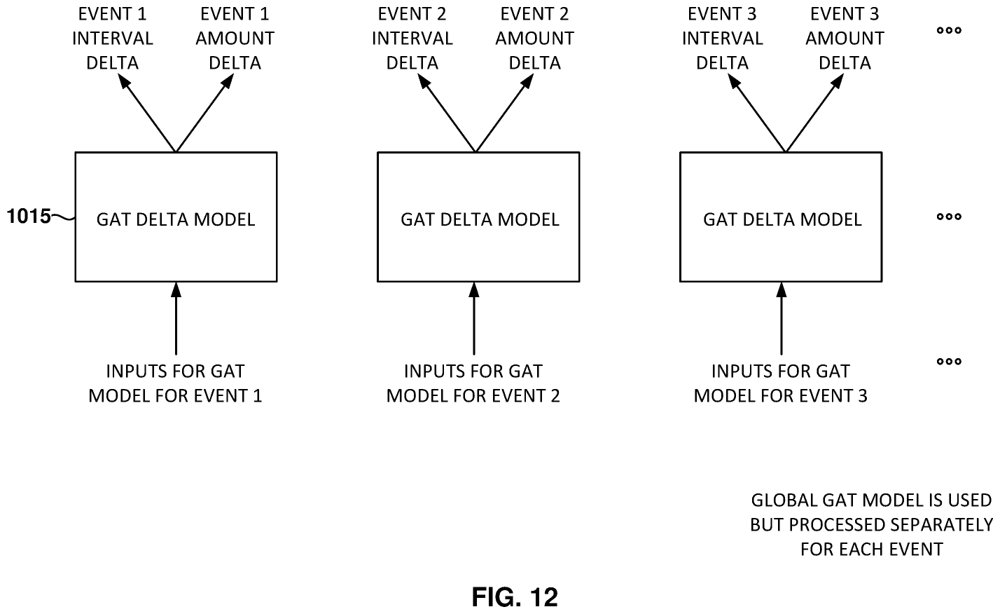

FIG. 12 is a flowchart of a method for processing each event, according to some examples. The GAT model 1015 is used to calculate the event interval delta and the amount delta based on the inputs for the model that include the shipment planning for the user.

Once the intervals and amounts are calculated for all the nodes, the outputs are combined to obtain the new expected plans for shipment on deliveries, such as the example illustrated above with reference to FIG. 9.

Experiments were performed using historical data from a global consumer goods company with complex supply chain networks. The GSP models were trained on 18 months of historical data from March 2021 to August 2022, validated on the subsequent four months, and then tested on a 4-month hold-out dataset from 2023. The dataset covers 51 high-volume SKUs. Each SKU-week combination has a unique network graph topology. The networks include a varying number of nodes, from 2 to 50, and a varying number of edges, from 1 to 91.

In the experiments with different methods, 4-week ahead demand predictions at the SKU/node level were used with wMAPEs ranging from 90% to 105% by forecasted timestep. The results showed that the planned shipments exhibited significant inaccuracies when compared to the actual shipments and were frequently not executed as intended.

The results showed that GSP models substantially outperformed the planned shipments and Croston's method in terms of both the edge-level daily outgoing supply sMACE and the node-level weekly inventory wMAPE.

Experimentation confirmed that the outstanding performance metrics of GSP can mainly be attributed to its remarkable capability to detect systematic deviation patterns observed historically between actual and planned shipment events. These encompass deviations in both quantity (lower and higher) and timing (earlier and later) that are evident at the SKU/edge levels. For instance, certain nodes consistently delayed their outgoing supply events compared to the originally planned timings when there were recurring delays occurring in incoming supply from parent nodes. GSP effectively leveraged these patterns to enhance predictions for future event quantities and timings, all while adhering to constraints. It was also noticed that GSP predictions based on GNN embeddings could incorporate the demand and inventory statuses of both source and destination nodes, as well as neighboring nodes. In some experiments where GSP used α=0.5 and was equipped with a loss function that evenly weights errors in edge-level cumulative outgoing supply predictions and node-level inventory predictions, showcased the best overall performance.

In summary, although accurate demand forecasting is a fundamental component of supply chain optimization, it is not the only necessity. Obtaining precise and reliable predictions for supply and inventory across all nodes and edges in supply chain networks is equally essential and challenging. The problem is addressed by the GNN-based probabilistic approach that attains network-wide, reliable supply predictions while adhering to node-level supply capacity constraints. The designed loss function for model training, which combines cumulative supply prediction errors and inventory prediction errors, delivers robust performance on critical metrics.

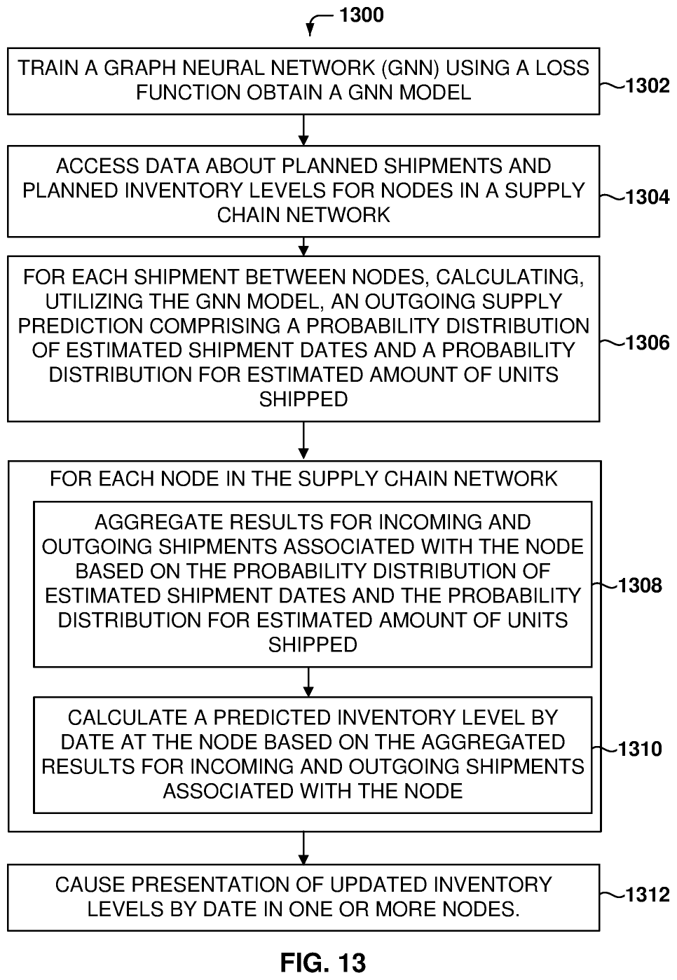

FIG. 13 is a flowchart of a method 1300 for estimating supply and inventory in a supply chain network, according to some examples. While the various operations in this flowchart are presented and described sequentially, one of ordinary skill will appreciate that some or all of the operations may be executed in a different order, be combined or omitted, or be executed in parallel.

Operation 1302 is for training a Graph Neural Network (GNN) using a loss function to obtain a GNN model. The loss function is configured to minimize cumulative supply prediction errors and inventory-level prediction errors. In some examples, the GNN can be a Graph Attention Network (GAT) or a Graph-Based Transformer Network, but other examples may utilize any other type of GNN.

From operation 1302, the method 1300 flows to operation 1304 to access data about planned shipments and planned inventory levels for nodes in a supply chain network. Each planned shipment has a planned shipping date and a planned unit amount.

From operation 1304, the method 1300 flows to operation 1306, where, for each shipment between nodes, a calculation is made, utilizing the GNN model, an outgoing supply prediction comprising a probability distribution of estimated shipment dates and a probability distribution for the estimated amount of units shipped.

After operation 1306, operations 1308 and 1310 are performed for each node in the supply chain network. Operation 1308 is for aggregating results for incoming and outgoing shipments associated with the node based on the probability distribution of estimated shipment dates and the probability distribution for the estimated amount of units shipped.

From operation 1308, the method 1300 flows to operation 1310 to calculate a predicted inventory level by date at the node based on the aggregated results for incoming and outgoing shipments associated with the node.

From operation 1310, the method 1300 flows to operation 1312 for causing the presentation of updated inventory levels by date in one or more nodes.

In one example, the loss function includes a predicted cumulative daily quantity vector for the nodes in the supply chain network and an actual cumulative daily quantity vector of outgoing supply for the nodes in the supply chain network.

In one example, calculating the outgoing supply prediction comprises calculating a normalized cumulative error over a planning horizon, wherein calculating the normalized cumulative error comprises: calculating a predicted cumulative quantity vector; calculating an actual cumulative daily quantity vector; and normalizing a difference between the predicted cumulative quantity vector and the actual cumulative daily quantity vector based on an actual daily quantity.

In one example, an input to the GNN model includes planned shipment events and demand forecasting over a predefined time horizon.

In one example, the GNN model is a delta model and calculates incremental modifications to the planned shipments and planned inventory levels.

In one example, the GNN model is a horizon model that calculates shipments and inventory levels without considering the data about planned shipments and planned inventory levels.

In one example, the GNN model is a hybrid model that utilizes a delta model for a period within a planning horizon and a hybrid model for times outside the period in the planning horizon.

In one example, aggregating results for the node further comprises calculating a cumulative predicted supply over by date, calculating a cumulative actual supply by date, and calculating a cumulative supply prediction error based on the cumulative predicted supply and the cumulative actual supply.

In one example, the node features for the GNN model comprise demand information, planned shipment information, and edge-level features corresponding to shipments between two nodes.

In one example, an output of the GNN model comprises a shipment event delta probability and a shipped quantity scaler.

In one example, the method 1300 further comprises creating a directional graph for the nodes in the supply chain network, the directional graph comprising edges between nodes in the supply chain network, and creating a reverse graph of the directional graph with the same nodes and features as the directional graph and with directions of edges reversed.

### Appendix A—Graph Attention Networks (GAT)

Graph Attention Networks (GAT) are a type of GNN architecture designed to assign dynamic attention weights to neighboring nodes in graph convolutions. In GAT, dynamic attentions enable a node to selectively attend to its neighboring nodes that are highly relevant in its supply predictions. Provided both node features h⁽⁰⁾ (=x) and edge features e(=a) for G=(V,E) with edges from neighboring source nodes j ∈ N_{src}(i)={j|(j,i) ∈ E} to node i, the update at layer (l) is:

$${h}_{i}^{( l )} σ ( {α}_{ij}^{( i - 1 )} {W}_{0}^{( i - 1 )} {h}_{j}^{( i - 1 )} + {\sum }_{j ∈ {N}_{src} ( i )} {α}_{ij}^{( l - 1 )} {W}_{l}^{( l - 1 )} {h}_{j}^{( l - 1 )} + {W}_{2}^{( l - 1 )} {e}_{ji} ) \qquad ( 18 )$$

In (18), αᵢⱼ^{(l-1)}=softmax j(oᵢⱼ^{l-1)}) ∈ [symbol] is a dynamic attention for edge (j,i) using the following equation:

$${o}_{ij}^{( l - 1 )} = {e}^{T ( l - 1 )} Leaky Re LU ( {W}_{0}^{( l - 1 )} {h}_{i}^{( l - 1 )} + {W}_{1}^{( l - 1 )} {h}_{j}^{( l - 1 )} + {W}_{2}^{( l - 1 )} {e}_{ji} ) . \qquad ( 19 )$$

GAT_{XA} denotes the L-layered graph convolution network that makes iterative updates l=1,2, . . . ,L and calculates h(L) as follows:

$$h ( L ) - GATXA ( {h}^{( 0 )} , e , ; {ϕ}_{XA} ) = \{ {h}_{v}^{( L )} ∈ {ℝ}^{B} : v ∈ {ℝ}^{B \times \vert v \vert} \qquad ( 20 )$$

In (20), ϕ_{XA}={W₀^{(l-1)}, W₁^{(l-1)}, W₂^{(l-1)}, c^{T(l-1)}:l ∈ {1,2, . . . ,L}} are the set of all learned parameters of GAT_{XA} and B is the embedding dimension.

### Appendix B—Model Training Details

Using the Adam optimizer, experiments used learning rates within the range of 1e-5 to 1e-2, incremented in factors of 10, varying the batch sizes among 1, 4, and 8.

GAT_{XA} incorporated LeakyReLU activation applied between each convolution layer. Using 2 or 3 convolution layers with 3 or 8 multi-head attentions for GAT_{XA}, there were also variations for the hidden dimension size. The mlpᵣ employed 2 or 3 hidden layers with LeakyReLU activation before the output layer with a sigmoid output function. The mlpₚ employed 2 or 3 hidden layers with LeakyReLU activation before the output layer with a GumbelSoftmax output function.

### APPENDIX C—sMACE

The daily outgoing supply prediction sMACE is defined as:

$$s MACE = \frac{{\sum }_{h ∈ H} \vert {\hat{Q}}_{vw}^{day , t} ( h ) - {Q}_{vw}^{day , t} \vert}{{\sum }_{( t , ( v , w ) ∼ 𝒟 )} {\sum }_{h ∈ H} {q}_{vw}^{day , t} ( h )} \times 100 \% \qquad ( 21 )$$

In (21), [symbol] \hat{ }^{day}ᵥₛ, ^{t}(h) and [symbol] ^{day}_{vw}, ^{t}(h) are the predicted and actual cumulative daily outgoing quantities from the forecasted timestep 0 to the forecasted timestep h for the edge from node v to node w at the prediction time t (=the start of day t), respectively. Also, q_{vw}^{day,t}(h) is the predicted daily outgoing quantity on the forecasted timestep h.

For the actual shipment quantity α_{vw}^{i|t} actual of event i on the edge from source node v to destination node w at the prediction time t, if α_{vw}^{i|t} actual has been predicted to occur either δ_{vw}^{i|t}, actual timesteps earlier or later (i.e., predicted occurrence time \hat{T}_{vw}^{i|t}, actual +δ_{vw}^{i|t}, actual), the error contribution of aα_{vw}^{i|t},actual×| δ_{vw}^{i|t} , actual| contributes to the numerator of sMACE.

For the sake of conceptual clarity, consider an illustrative scenario with actual quantities [0, 100, 0, 0] over 4 timesteps. The cumulative actual quantities=[0, 100, 100, 100]. We compare three predictive models, such as M1 =[0, 0, 100, 0], M2=[100, 0, 0, 0], and M3=[0, 0, 0, 0].

M1 and M2 have a wMAPE of 200%, while M3 has 100%. Note that wMAPE (=weighted Mean Absolute Percentage Error) is defined as the sum of the absolute quantity errors (=samples of|predicted quantity−actual quantity|) divided by the sum of the actual quantities.

In the context of sMACE, when an actual quantity (representing a step increase in the cumulative actual quantity function) is predicted to occur either d timesteps earlier (d<0) or later (d>0), it contributes an error equal to the quantity multiplied by |d|. Therefore, in terms of sMACE, both M1 and M2 have a score of 100%, whereas M3 scores 300%. In more detail,
M1: 1-timestep late prediction for 100 actual quantity=100×1=100 error; Cumulative predicted quantities=[0, 0, 100, 100]; Absolute cumulative quantity error =[0, 100, 0, 0]; sMACE=100/100×100%=100%.
M2: 1-timestep early prediction for 100 actual quantity=100×1=100 error; Cumulative predicted quantities=[100, 100, 100, 100]; Absolute cumulative quantity errors=[100, 0, 0, 0]; sMACE=100/100×100%=100%.
M3: at least 3-timestep late prediction for 100 actual quantity=100×3=300 error; Cumulative predicted quantities=[0, 0, 0, 0]; Absolute cumulative quantity errors=[0, 100, 100, 100]; sMACE=300/100 ×100%=300%.

Further, sMACE may be extended to involve a linear, increasing, or decreasing penalty function over the prediction time error of δ, which is allowed to be defined in each domain δ<0 and δ>0.

$$penalty ( δ ) = \{ \begin{matrix}{\sum }_{j = 1}^{δ} φ + ( j ) & if δ > 0 \\ {\sum }_{j = δ}^{- 1} φ - ( j ) & if δ < 0 \\ 0 & if δ = 0\end{matrix} \qquad ( 22 )$$

In (22), φ+(j) and φ−(j) are weight functions. Some possible choices for φ+(j) are defined as c₁(1+η₁(j−1)) or c₁η₂^{(j-1)}. Similarly, φ−(j)=c₂(1+η₃(|j|−1)) or c₂n₄^{(|j|-1)}. In these equations, c₁ and c₂ are positive constant cost parameters. Also, η₁,η₃ ∈ [0,1] are overweighting ratio parameters, whereas η₂,η₄ ∈ (0,1) are discounting ratio parameters.

$$Generalized sMACE = \frac{\sum \text{?} \sum \text{?} \text{?} 𝔼 \text{?} [ penalty ( δ \text{?} ) ]}{\sum \text{?} \sum \text{?} \text{?}} \times 100 \% \qquad ( 23 )$$

$$\text{?} \text{indicates text missing or illegible when filed}$$

In (23), [symbol] is the set of all actual events over the time horizon. The linear penalty (δ)=| δ |, where φ+(j)=φ−(j)=1.

### Appendix D—Inventory Prediction Process

Defining T_{week} as the temporal transformation operator that aggregates daily samples into weekly bucketed samples, referring to the calendar information: Then, the predicted weekly quantity vector of outgoing supply is calculated as:

$${\tilde{q}}_{υ w}^{week , t} = {𝒯}_{week} [ {\tilde{q}}_{υ w}^{day , t} ] ∈ {ℝ}^{\vert W \vert} \qquad ( 24 )$$

For the weekly time horizon W={0,1,2, . . . , |W|−1}, where |W|=|H|/7. \hat{q}_{vw}^{day,t}(h) and \hat{q}_{vw}^{week,t} are the daily outgoing supply quantity at day h ∈ H and the weekly outgoing supply quantity at week w ∈ W, respectively. In some examples, weekly demand forecasting and planning features are accessible. Therefore, making weekly granular inventory predictions is a reasonable choice.

Supposing that, for any outgoing supply at day t+h, the discrete probability distribution of the predicted lead time variable k ∈ H is provided as P_{LT,vw}^{i+h}(k) where P_{LT,vw}^{t+h}(k) is the probability of predicted lead time k=k. The received (incoming) daily and weekly supply quantities at the destination node w are computed as:

$$q \text{?} = {\sum }_{\text{?}} {{\sum }^{\text{?}}}_{k ∈ H} q \text{?} ( h ) p \text{?} ( k ) {ϵ}^{( h \div k )} \cdot q \text{?} = {𝒯}_{week} \text{?} \qquad ( 25 )$$

$$\text{?} \text{indicates text missing or illegible when filed}$$

Dᵥ,w|predt, S\hat{ }ᵥ^{w|t}, and A\hat{ }ᵥ^{w}|^{t} are predicted demand, predicted incoming supply, and predicted outgoing supply for week w as predicted at the start of week t, respectively. Defining N_{dest}(v) as the set of all neighboring destination (child) nodes w for a given source node v. That is, w ∈ N_{dest}(v)=Pa_{G}R(v) where G^{R} is the reverse graph of G with the same nodes and features but with the directions of all edges reversed.

$$predicted outgoing supply \text{?} = {\sum }_{\text{?}} q \text{?} ( w ) \qquad ( 26 )$$

$$\text{?} \text{indicates text missing or illegible when filed}$$

Defining N_{src}(v) as the set of all neighboring source (parent) nodes u′ for a given node v. That is, u′ ∈ N_{src}(v)=Pa_{G}(v) where G is the network graph.

$$predicted incoming supply S \text{?} = {\sum }_{\text{?}} q \text{?} ( w ) \qquad ( 27 )$$

$$\text{?} \text{indicates text missing or illegible when filed}$$

It is set to satisfy that the predicted outgoing supply A\hat{ }^{w}ᵥ|^{t} should not be greater than the supply capacity constraint (i.e., no more outgoing supply than available capacity) Ŷᵥ^{w|t}=Îᵥ^{w|t}+Ŝₜ^{w|t}−D_{v,pred}. Thus, if adjustments are made to a_{v,w}^{i|t} for any event I that impacts the outgoing supply at week w:

$$\text{?} := ( Y \text{?} / A \text{?} ) \text{?} for any event i ∈ \{ i ∈ ℕ \vert u \text{?} ( w ) > 0 \} \qquad ( 28 )$$

$$\text{?} \text{indicates text missing or illegible when filed}$$

Then, the predicted inventory at the start of week w+1,Îᵥ^{w+j|t} is updated as: for w ∈ W,

predicted next start inventory

$$I \text{?} = I \text{?} + S \text{?} - D \text{?} - A \text{?} \qquad ( 29 )$$

$$\text{?} \text{indicates text missing or illegible when filed}$$

In (29), Îᵥ^{t|t} is the actual inventory at the start of week t, Iᵥⁱ actual. Also, we define the weekly predicted inventory and weekly actual inventory vectors for node v at week t as:

$$I \text{?} = \{ I \text{?} \vert w ∈ W \} \text{?} \qquad ( 30 )$$

$${I}_{υ}^{week , t} = \{ {I}_{υ , actual}^{t + w} \vert w ∈ W \}$$

$$\text{?} \text{indicates text missing or illegible when filed}$$

### Appendix E—Supply Capacity Constraint Violation Error

The weekly supply capacity constraint violation error κ is defined as:

$$\text{?} = \frac{\sum \text{?} \sum \text{?} ( A \text{?} - Y \text{?} )}{{\sum }_{( t , υ ) ∼ 𝒟} {\sum }_{w ∈ W} I \text{?}} \times 100 \% \qquad ( 31 )$$

$$\text{?} \text{indicates text missing or illegible when filed}$$

### Appendix F—Iterative Predictions to Satisfy the Supply Capacity Constraint

Supposing that any node in the supply chain network can use the supply it receives during a given week to fulfill both demand and outgoing supply needs for that same week. In this context, the incoming supply to a node, which includes shipments sent from its source nodes and received to that node within the same week, directly affects its supply capacity constraint to determine the maximum available outgoing supply during the same week. However, typical GNN implementations do not provide support for sequential supply predictions along cascading directional graphs; instead, they predict the supply quantities of all edges across the network simultaneously. As a result, we present an iterative inference approach to ensure that supply capacity constraints at each node are satisfied.

Further, q\hat{ }ᵤ^{day}, ᵥ, ^{,t,Iter=0} is used to represent the initial unconstrained prediction of daily supply quantities on the edge from source node u′ and destination node v. Also, q\hat{ }ᵤ^{day}, ᵥ, ^{,t,}0:(7^{Iter=n}_{w-1}) denotes the constrained prediction of daily supply quantities during the n-th iteration up to the start of week w (=0,1, . . . , |W|−1).

TABLE 1
GSP (α = 0.5) Performances for Iterations
(Mean ± SD, Calculated Across 4 Weeks)

| | (a) Daily | (b) Weekly | (c) Weekly |
|---|---|---|---|
| | Outgoing | Inventory | Constraint |
| Iterations | Supply sMACE | wMAPE | Error κ |
| 0 | 99.94 ± 0.1% | 30.43 ± 0.3% | 3.69 ± 0.02% |
| 1 | 99.89 ± 0.2% | 30.40 ± 0.3% | 3.57 ± 0.02% |
| 2 (ρ < 0.005) | 98.58 ± 0.1% | 29.92 ± 0.2% | 3.45 ± 0.01% |

Based on the predictions from the previous (n−1)-th iteration. Furthermore, q\hat{ }ᵤ^{day}, ᵥ,^{,t,} 7w:(7^{Iter=(n-1)}_{|W|-}1) is the prediction made during the (n−1)-th iteration, spanning from week w to week (|W|−1). Then, it is defined the concatenated vector that represents the revised prediction for the entire time horizon (7|W|=|H| days) estimated at the start of week w during the n-th iteration:

$$q \text{?} = q \text{?} ⊕ q \text{?} \qquad ( 32 )$$

$$\text{?} \text{indicates text missing or illegible when filed}$$

Here, ⊕ is the vector concatenation operator. Next, the received (incoming) daily and weekly supply quantity vectors at the node v in any iteration n≥1 are computed as:

$$q \text{?} = {\sum }_{\text{?}} {\sum }_{k ∈ H} q \text{?} ( h ) \text{?} p \text{?} ( k ) {e}^{( h \div k )} \qquad ( 33 )$$

$$q \text{?} = {𝒯}_{week} [ q \text{?} ] \qquad ( 34 )$$

$$\text{?} \text{indicates text missing or illegible when filed}$$

In each iteration n(≥1), for every week w=0,1, . . . , |W|−1, the node v's incoming supply Ŝᵥ^{w|t} and outgoing supply capacity Ŷᵥ^{w|t} are updated:

$$S \text{?} = {\sum }_{\text{?}} \text{?} \qquad ( 35 )$$

$$Y \text{?} = I \text{?} + S \text{?} - D \text{?}$$

$$\text{?} \text{indicates text missing or illegible when filed}$$

Then, if the predicted outgoing supply Âᵥ^{w|t}= [symbol] \hat{q}_{vw}^{week,t}(w) is greater than the supply capacity constraint Ŷᵥ^{w|t}, adjustments to â_{vw}^{i|t} are made for any event i that impacts the outgoing supply at week w:

$$if A \text{?} > Y \text{?} , \text{?} := ( Y \text{?} / A \text{?} ) \text{?} for any event i ∈ \{ i ∈ N \vert \text{?} ( w ) > 0 \} \qquad ( 36 )$$

$$\text{?} \text{indicates text missing or illegible when filed}$$

Accordingly, q\hat{ }_{vw}^{day,t,Iter=n} a is updated, and the next start inventory Îᵥ^{w+l|t}=Îᵥ^{w|t}+Ŝᵥ^{w|t}−D_{v,pred}^{w|t}−Aᵥ^{w|t}.

Multiple iterations are performed until the averaged relative change ρ becomes smaller than ∈.

$$ρ = {𝔼}_{( t , ( {u}^{′} , υ ) ) ∼ 𝒟} [ \frac{{‖ q \text{?} - q \text{?} ‖}_{2}}{{‖ q \text{?} ‖}_{2}} ] < ϵ \qquad ( 37 )$$

$$\text{?} \text{indicates text missing or illegible when filed}$$

In (37), ∈ is a small positive threshold hyperparameter (e.g., 0.005).

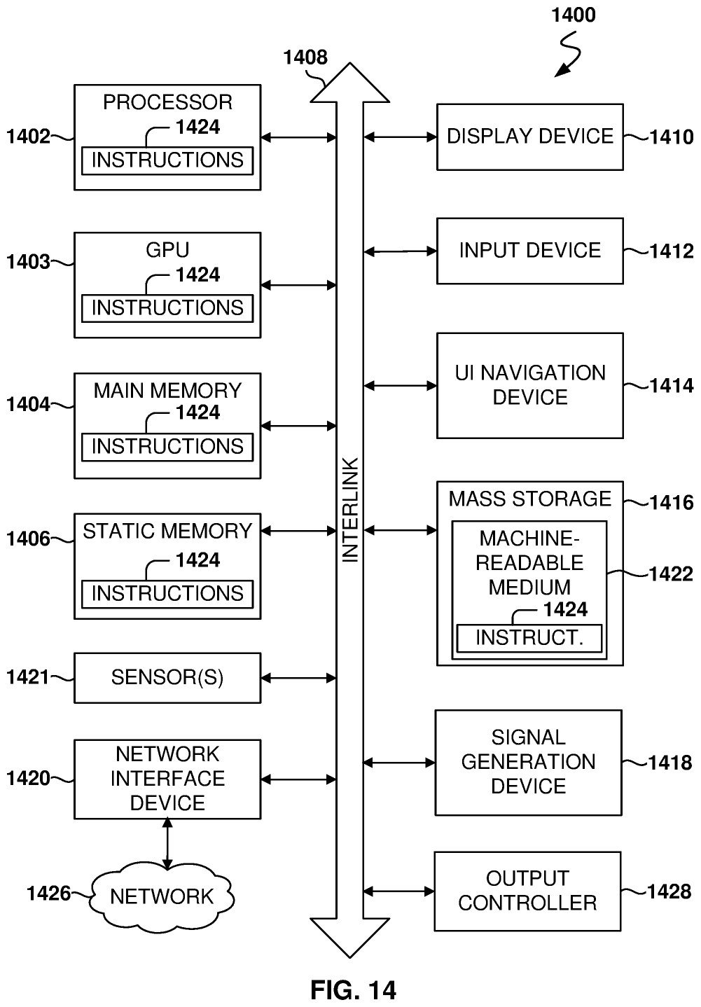

FIG. 14 is a block diagram illustrating an example of a machine 1400 upon or by which one or more example process embodiments described herein may be implemented or controlled. In alternative embodiments, the machine 1400 may operate as a standalone device or be connected (e.g., networked) to other machines. In a networked deployment, the machine 1400 may operate in the capacity of a server machine, a client machine, or both in server-client network environments. In an example, the machine 1400 may act as a peer machine in a peer-to-peer (P2P) (or other distributed) network environment. Further, while only a single machine 1400 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, various components, or mechanisms. Circuitry is a collection of circuits implemented in tangible entities, including hardware (e.g., simple circuits, gates, logic). Circuitry membership may be flexible over time and underlying hardware variability. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits), including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other circuitry components when the device operates. In an example, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The machine 1400 (e.g., computer system) may include a hardware processor 1402 (e.g., a central processing unit (CPU), a hardware processor core, or any combination thereof), a graphics processing unit (GPU 1403), a main memory 1404, and a static memory 1406, some or all of which may communicate with each other via an interlink 1408 (e.g., bus). The machine 1400 may further include a display device 1410, an alphanumeric input device 1412 (e.g., a keyboard), and a user interface (UI) navigation device 1414 (e.g., a mouse). In an example, the display device 1410, alphanumeric input device 1412, and UI navigation device 1414 may be a touch screen display. The machine 1400 may additionally include a mass storage device 1416 (e.g., drive unit), a signal generation device 1418 (e.g., a speaker), a network interface device 1420, and one or more sensors 1421, such as a Global Positioning System (GPS) sensor, compass, accelerometer, or another sensor. The machine 1400 may include an output controller 1428, such as a serial (e.g., universal serial bus (USB)), parallel, or other wired or wireless (e.g., infrared (IR), near field communication (NFC)) connection to communicate with or control one or more peripheral devices (e.g., a printer, card reader).

The processor 1402 refers to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor 1402 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

The processor 1402 may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. The processor 1402 may be emulated in software, running on a physical processor, as a virtual processor or virtual circuit. The virtual processor may behave like an independent processor but is implemented in software rather than hardware.

The mass storage device 1416 may include a machine-readable medium 1422 on which one or more sets of data structures or instructions 1424 (e.g., software) embodying or utilized by any of the techniques or functions described herein. The instructions 1424 may also reside, completely or at least partially, within the main memory 1404, within the static memory 1406, within the hardware processor 1402, or the GPU 1403 during execution thereof by the machine 1400. For example, one or any combination of the hardware processor 1402, the GPU 1403, the main memory 1404, the static memory 1406, or the mass storage device 1416 may constitute machine-readable media.

While the machine-readable medium 1422 is illustrated as a single medium, the term “machine-readable medium” may include a single medium or multiple media (e.g., a centralized or distributed database and associated caches and servers) configured to store one or more instructions 1424.

The term “machine-readable medium” may include any medium that is capable of storing, encoding, or carrying instructions 1424 for execution by the machine 1400 and that causes the machine 1400 to perform any one or more of the techniques of the present disclosure or that is capable of storing, encoding, or carrying data structures used by or associated with such instructions 1424. Non-limiting machine-readable medium examples may include solid-state memories and optical and magnetic media. For example, a massed machine-readable medium comprises a machine-readable medium 1422 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1424 may be transmitted or received over a communications network 1426 using a transmission medium via the network interface device 1420.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented separately. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various embodiments of the present disclosure. In general, structures and functionality are presented as separate resources in the example; configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. Accordingly, the specification and drawings are to be regarded in an illustrative rather than a restrictive sense.

What is claimed is:

1. A computer-implemented method comprising:
training a Graph Neural Network (GNN) using a loss function to obtain a GNN model, the loss function configured to minimize cumulative supply prediction errors and inventory-level prediction errors;
accessing data about planned shipments and planned inventory levels for nodes in a supply chain network, each planned shipment having a planned shipping date and a planned unit amount;
for each shipment between nodes, calculating, utilizing the GNN model, an outgoing supply prediction comprising a probability distribution of estimated shipment dates and a probability distribution for estimated amount of units shipped;
for each node in the supply chain network:
aggregating results for incoming and outgoing shipments associated with the node based on the probability distribution of estimated shipment dates and the probability distribution for estimated amount of units shipped; and
calculating a predicted inventory level by date at the node based on the aggregated results for incoming and outgoing shipments associated with the node; and
causing presentation of updated inventory levels by date in one or more nodes.

2. The method as recited in claim 1, wherein the loss function includes a predicted cumulative daily quantity vector for the nodes in the supply chain network and an actual cumulative daily quantity vector of outgoing supply for the nodes in the supply chain network.

3. The method as recited in claim 1, wherein calculating the outgoing supply prediction comprises calculating a normalized cumulative error over a planning horizon, wherein calculating the normalized cumulative error comprises:
calculating a predicted cumulative quantity vector;
calculating an actual cumulative daily quantity vector; and
normalizing a difference between the predicted cumulative quantity vector and the actual cumulative daily quantity vector based on an actual daily quantity.

4. The method as recited in claim 1, wherein an input to the GNN model includes planned shipment events and demand forecasting over a predefined time horizon.

5. The method as recited in claim 1, wherein the GNN model is a delta model and calculates incremental modifications to the planned shipments and planned inventory levels.

6. The method as recited in claim 1, wherein the GNN model is a horizon model that calculates shipments and inventory levels without considering the data about planned shipments and planned inventory levels.

7. The method as recited in claim 1, wherein the GNN model is a hybrid model that utilizes a delta model for a period within a planning horizon and a hybrid model for times outside the period in the planning horizon.

8. The method as recited in claim 1, wherein aggregating results for the node further comprises:
calculating a cumulative predicted supply over by date;
calculating a cumulative actual supply by date; and
calculating a cumulative supply prediction error based on the cumulative predicted supply and the cumulative actual supply.

9. The method as recited in claim 1, wherein node features for the GNN model comprise demand information, planned shipment information, and edge-level features corresponding to shipments between two nodes.

10. The method as recited in claim 1, wherein an output of the GNN model comprises a shipment event delta probability and a shipped quantity scaler.

11. The method as recited in claim 1, further comprising:
creating a directional graph for the nodes in the supply chain network, the directional graph comprising edges between nodes in the supply chain network; and
creating a reverse graph of the directional graph with same nodes and features as the directional graph and with directions of edges reversed.

12. A system comprising:
a memory comprising instructions; and
one or more computer processors, wherein the instructions, when executed by the one or more computer processors, cause the system to perform operations comprising:
training a Graph Neural Network (GNN) using a loss function to obtain a GNN model, the loss function configured to minimize cumulative supply prediction errors and inventory-level prediction errors;
accessing data about planned shipments and planned inventory levels for nodes in a supply chain network, each planned shipment having a planned shipping date and a planned unit amount;
for each shipment between nodes, calculating, utilizing the GNN model, an outgoing supply prediction comprising a probability distribution of estimated shipment dates and a probability distribution for estimated amount of units shipped;
for each node in the supply chain network:
aggregating results for incoming and outgoing shipments associated with the node based on the probability distribution of estimated shipment dates and the probability distribution for estimated amount of units shipped; and
calculating a predicted inventory level by date at the node based on the aggregated results for incoming and outgoing shipments associated with the node; and
causing presentation of updated inventory levels by date in one or more nodes.

13. The system as recited in claim 12, wherein the loss function includes a predicted cumulative daily quantity vector for the nodes in the supply chain network and an actual cumulative daily quantity vector of outgoing supply for the nodes in the supply chain network.

14. The system as recited in claim 12, wherein calculating the outgoing supply prediction comprises calculating a normalized cumulative error over a planning horizon, wherein calculating the normalized cumulative error comprises:
calculating a predicted cumulative quantity vector;
calculating an actual cumulative daily quantity vector; and
normalizing a difference between the predicted cumulative quantity vector and the actual cumulative daily quantity vector based on an actual daily quantity.

15. The system as recited in claim 12, wherein an input to the GNN model includes planned shipment events and demand forecasting over a predefined time horizon.

16. The system as recited in claim 12, wherein the GNN model is a delta model and calculates incremental modifications to the planned shipments and planned inventory levels.

17. The system as recited in claim 12, wherein the GNN model is a horizon model that calculates shipments and inventory levels without considering the data about planned shipments and planned inventory levels.

18. A non-transitory machine-readable storage medium including instructions that, when executed by a machine, cause the machine to perform operations comprising:
training a Graph Neural Network (GNN) using a loss function to obtain a GNN model, the loss function configured to minimize cumulative supply prediction errors and inventory-level prediction errors;
accessing data about planned shipments and planned inventory levels for nodes in a supply chain network, each planned shipment having a planned shipping date and a planned unit amount;
for each shipment between nodes, calculating, utilizing the GNN model, an outgoing supply prediction comprising a probability distribution of estimated shipment dates and a probability distribution for estimated amount of units shipped;
for each node in the supply chain network:
aggregating results for incoming and outgoing shipments associated with the node based on the probability distribution of estimated shipment dates and the probability distribution for estimated amount of units shipped; and
calculating a predicted inventory level by date at the node based on the aggregated results for incoming and outgoing shipments associated with the node; and
causing presentation of updated inventory levels by date in one or more nodes.

19. The non-transitory machine-readable storage medium as recited in claim 18, wherein the loss function includes a predicted cumulative daily quantity vector for the nodes in the supply chain network and an actual cumulative daily quantity vector of outgoing supply for the nodes in the supply chain network.

20. The non-transitory machine-readable storage medium as recited in claim 18, wherein calculating the outgoing supply prediction comprises calculating a normalized cumulative error over a planning horizon, wherein calculating the normalized cumulative error comprises:
calculating a predicted cumulative quantity vector;
calculating an actual cumulative daily quantity vector; and
normalizing a difference between the predicted cumulative quantity vector and the actual cumulative daily quantity vector based on an actual daily quantity.
